(19) United States
(12) Patent Application Publication
(10) Pub. No.: US 2004/0057829 A1
(43) Pub. Date: Mar. 25, 2004

(54) High efficiency vertical axis windmill

(76) Inventor: Ghazi Khan, Fremont, CA (US)

Correspondence Address: GHAZI A. KHAN, 3328 BAYLIS ST., FREMONT, CA, 94538, US

(21) Appl. No.: 10/252,223

(22) Filed: Sep. 23, 2002

(51) Int. Cl. F03D 3/06

(52) U.S. Cl. 416/17; 415/4.4

(57) ABSTRACT

A savonius type windmill with multiple openings covered with horizontal blinds to let the air flow in reducing the drag from one end of the rotor blade while completely shutting the other side of the rotor blade by the winds own force to produce maximum torque.

### PRIOR ART

In my previous patent applications “All weather windmills” and “All weather turbines” I have discussed a safety mechanism to withstand heavy storms and continuous stable PRM's through unstable weather patterns and building larger windmills which was not possible by the old technology however efficiency enhancement has been a challenge throughout this time till this day and now the art of enhanced efficiency has been disclosed by this present invention.

U.S. Patent Documents

| | | |
|---|---|---|
| 274541 | February 1883 | Zwiebel. |
| 1413411 | April 1922 | Lloyd et al. |
| 1766765 | June 1930 | Savonius. |
| 2007963 | July 1935 | Cleveland. |
| 4005947 | February 1977 | Norton et al. |
| 4037983 | July 1977 | Poeta. |
| 4039849 | August 1977 | Mater et al. |
| 4288200 | September 1981 | O'Hare. |
| 4359311 | November 1982 | Benesh. |
| 4362470 | December 1982 | Locastro et al. |
| 4474529 | October 1984 | Kinsey. |
| 4715776 | December 1987 | Benesh. |
| 4784568 | November 1988 | Benesh. |
| 4830570 | May 1989 | Benesh. |
| 4838757 | June 1989 | Benesh. |

Foreign Patent Documents

| | | |
|---|---|---|
| 37015 | January 1927 | DK. |
| 65940 | December 1924 | FI. |
| 658943 | June 1929 | FR. |
| 727519 | June 1932 | FR. |
| 797106 | October 1935 | FR. |
| 0961999 | May 1950 | FR |
| 2286955 | April 1976 | FR. |
| 2468003 | April 1981 | FR. |
| 2522074 | August 1983 | FR. |
| 821930 | November 1951 | DE. |
| 1628140 | February 1970 | DE. |
| 1916460 | October 1970 | DE. |
| 60-145464 | July 1985 | JP. |
| 270858 | March 1926 | GB. |
| 1518151 | July 1978 | GB. |
| WO81/03683 | December 1981 | WO. |

### OTHER REFERENCES

Augmentation of Power in Slow-Running Vertical-Axis Wind Rotors Using Multiple Vanes, Sivasegaram et al., Wind Engineering, vol. 7, No. 1. 1983. pp. 12-19. Design of a Prototype Improved Savonius Rotor: “As A System Totality”, Rao, pp. 967-973 (no date).

Article entitiled “Vertical Axis Wind Rotors-Status and Potential”. from Wind Energy Conservation, pp. 28-29 (no date, but published prior to date of application).

“The Savonius Super Rotor!” by Michael Hackleman reprinted from the Mother Earth News, No. 193 (no date, but published prior to date of application).

Mechanical Engineering, Vo. 53. May 1931. No. 5. “The S-Rotor and Its Applications” by Savonius.

The Wind Power Book by Jack Park. 1981. pp. 93-95.

Newsletter 1. A Supplement to Wind and Wind Spinners. Jul. 1975. pp. 1-26.

“Wind Tunnel Performance Data for Two-and Three-Bucket Savonius Rotors”, Report No. SAND 76-0131. July, 1977 authored by Blackwell et al.

Paper Presented at the Second International Symposium on Wind Energy Systems, held in Amsterdam, Netherlands, Oct. 3rd-6th, 1978. vol. 2. pp. F3-30 to F3-34.

### SUMMARY OF INVENTION

In this art the sail/wing or blade is perforated with vents (openings) based on the size of the vertical axis rotor blade and blinds are placed inside the blade in such a way that the wind coming from the vents open the blinds by its force and pass through it with least possible resistance and when this rotor blade comes into position facing the wind directly when the vents are behind the blinds, the wind close the blinds against the vents and the total blade becomes a large cavity with no vents at all. This principle drives the wind to put maximum pressure and a passage is provided to force the wind to move the rotor blade and pass through the space between the two inner edges of the rotor blades. In this process the opposing blade is made open to pass the wind directly through its open vents reducing the drag to its minimum translating into an increased efficiency.

### BRIEF DESCRIPTION OF DRAWINGS

FIG. 1 is the diagrammatic side views of this preferred embodiment wherein the wind is coming through the air vents.

FIG. 2 is the diagrammatic side view of this preferred embodiment wherein the wind is coming directly towards the blinds and the vents are in closed position.

FIG. 3 is the diagrammatic front view of the rotor assembly showing both wings one open and the second in close position.

FIG. 4 is the diagrammatic View from top showing grind direction and blinds open and close position

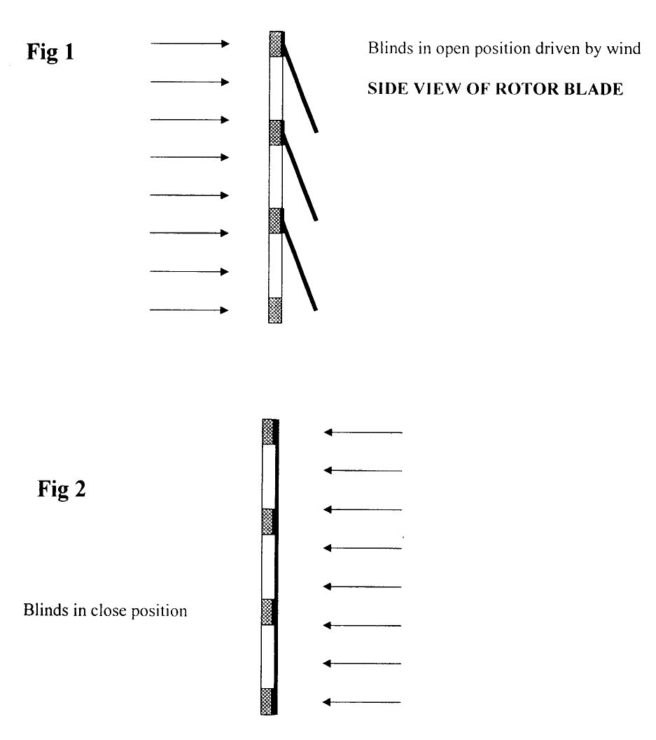

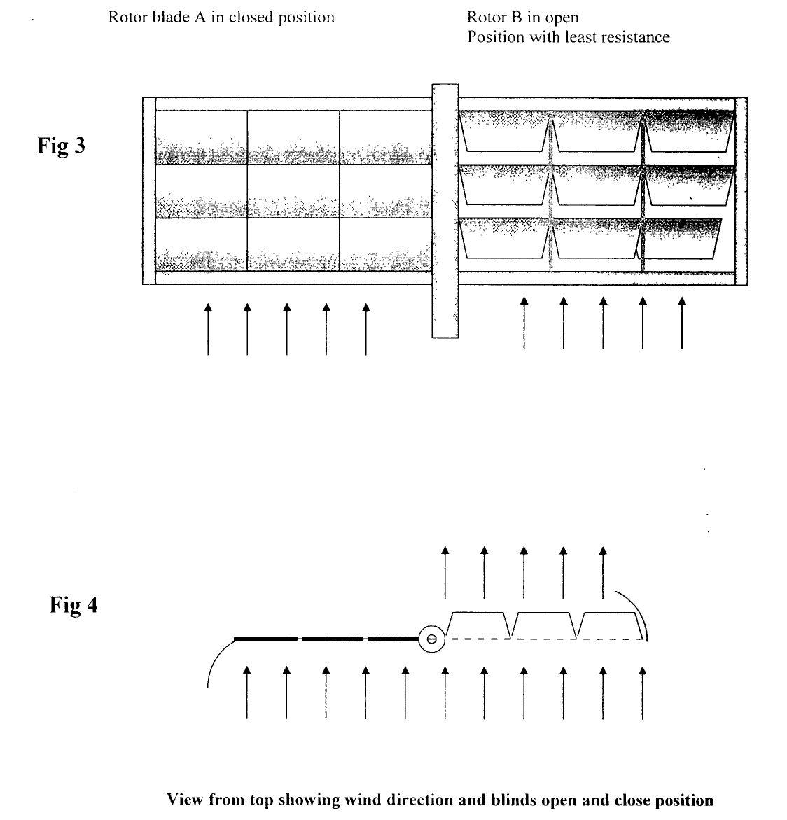

### DESCRIPTION OF THE PREFERRED EMBODIMENT

In this preferred embodiment the rotor blade is perforated with vents (openings) based on the size of the vertical axis rotor blade and blinds are placed inside the blade in such a way that the wind coming from the vents open the blinds by its force and pass through it with least possible resistance and when this rotor blade comes into position facing the wind directly when the vents are behind the blinds the wind close the blinds against the vents and the total blade becomes a large cavity with no vents at all. This principle drives the wind to put maximum pressure and a passage is provided to force the wind to move the rotor blade and pass through the space between the two inner edges of the rotor blades. In this process the opposing blade is made open to pass the wind directly through its open vents reducing the drag to its minimum translating into an increased efficiency. The safety mechanism balanced by centrifugal force and spring force is also placed as described in my previous patent applications named “All weather windmills” and “All weather wind turbines” makes it possible to rum it constantly without the need for a gear system in all kinds of windy conditions. The Preferred embodiment improves the efficiency by reducing the drag caused by the forward rotor blade moving against the wind.

1. An arrangement in which multiple openings are made on the rotor blades whether square, round, triangular, hexagonal, pentagon or any other shape or size to let the wind pass through it freely and may be a bare skeleton or perforated sheet of metal or plastic to keep the rotor blade structure in place with multiple openings.

2. These openings are covered with horizontal blinds inside the rotor blade which can only open inward letting the wind pass through them freely if wind is coming through the vent side, and closing the vents completely if the wind is coming facing the blinds directly and not through the vents

3. The shape of the rotor blade can be circular, flat rectangular, triangular, semi circle, pentagon, hexagonal or multi cornered so long, as the principle of horizontal blinds is applied whether the blinds are hanged independently or tied up in groups or semi groups in multi arrangement to act independently or collectively in a single column or multiple columns arrangement.
